(19) United States
(12) Patent Application Publication
(10) Pub. No.: US 2014/0107943 A1
(43) Pub. Date: Apr. 17, 2014

(54) GAS INTENSITY CALIBRATION METHOD AND SYSTEM

(71) Applicant: MILTON ROY COMPANY, Ivyland, PA (US)

(72) Inventors: Michael J. Birnkrant, Rocky Hill, CT (US); Marcin Piech, East Hampton, CT (US)

(73) Assignee: MILTON ROY COMPANY, Ivyland, PA (US)

(21) Appl. No.: 13/653,567

(22) Filed: Oct. 17, 2012

(51) Int. Cl. G01N 35/00; G06F 19/00

(52) U.S. Cl. 702/30

(57) ABSTRACT

An example method of calibrating a detected intensity of gas components includes measuring an intensity of a reference gas, measuring an intensity of a calibration gas, and calibrating a measurement of an intensity of a test gas using at least a measurement of the intensity of the reference gas and at least a measurement of the intensity of the calibration gas.

### BACKGROUND

This disclosure relates generally to a calibration method used when determining quality of a gas.

High-quality gas is typically worth more than low-quality gas. If gas is offered for sale, its price may depend on its quality. Determining the quality of other gases, such as atmospheric gas, indoor air, etc., may be useful for environmental reasons.

Components are the chemically independent constituents of a gas. Natural gas, an example type of gas, is made of several components, some of which are hydrocarbons. The quality of natural gas may be based on the enthalpy of combustion of its individual components.

One technique for determining the quality of gas involves optical sensors, which may suffer from drift and loss of calibration. Optical sensors that measure gas are especially susceptible because of fluctuating temperatures and pressures. Optical sensors used for gas content measurement typically require precision of better than ±0.5%. Such precision requires relatively complex mechanical systems.

### SUMMARY

An example method of calibrating a detected intensity of gas components includes measuring an intensity of a reference gas, measuring an intensity of a calibration gas, and calibrating a measurement of an intensity of a test gas using at least a measurement of the intensity of the reference gas and at least a measurement of the intensity of the calibration gas.

An example gas quality assessment system includes a detector configured to determining an intensity of a provided gas. A manifold is configured to selectively communicate a test gas, a reference gas, or a calibration gas to the detector as the provided gas. A controller is configured to determine a calibrated intensity measurement of the test gas, wherein the calibrated intensity measurement is calibrated based on an intensity measurement of the reference gas and the calibration gas.

### DESCRIPTION OF THE FIGURES

The various features and advantages of the disclosed examples will become apparent to those skilled in the art from the detailed description. The figures that accompany the detailed description can be briefly described as follows:

FIG. 1 shows an example gas component meter assembly.

FIG. 2 shows schematic view of an example system incorporating the FIG. 1 meter.

FIG. 3 shows a side view of a manifold of the FIG. 2 system.

FIG. 4 shows a flow of an example method of calibrating a measurement of a test gas.

FIG. 5 shows a plot of intensity verses time for gases monitored by the system.

FIG. 6 shows a plot of gas quality versus time of a test gas that was generated using a calibrated measurement of an intensity of the test gas.

FIG. 7 shows a highly schematic view of how the calibrated measurement of the intensity is used to determine quality.

### DETAILED DESCRIPTION

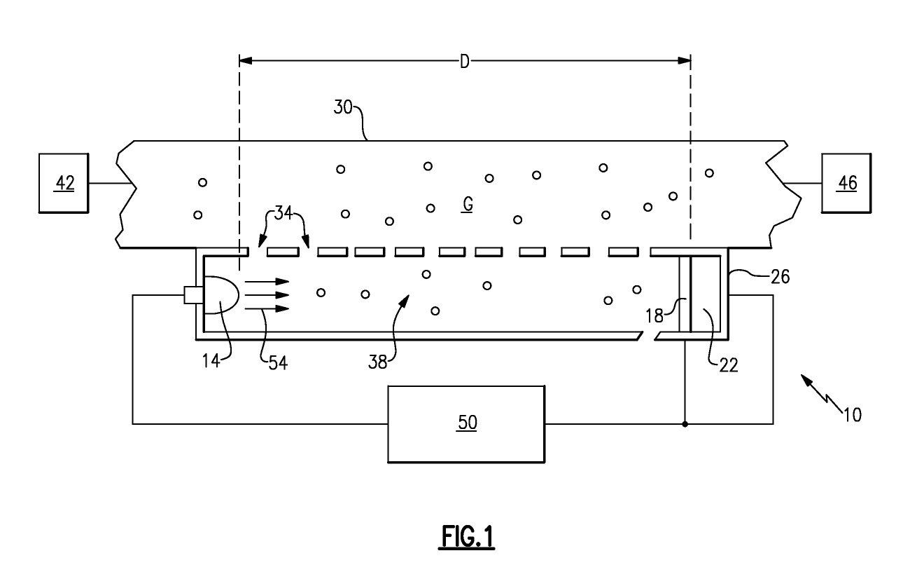

Referring to FIG. 1, an example gas component meter assembly 10 includes an infrared light source 14, a filter 18, and a detector 22 within a housing 26. The housing 26, in this example, is secured to a gas pipeline 30. Apertures 34 within the pipeline 30 and the housing 26 permit gas to communicate between an interior 38 of the housing 26 and the pipeline 30.

Gas G communicates through the pipeline 30 from a supply 42 to a destination 46. The example gas G is natural gas. The supply 42 is a utility company. The destination 46 is a home or business.

The example meter 10 determines the composition of the natural gas within the interior 38 (and thus the composition of gas within the pipeline 30). The composition is used to determine the quality of the natural gas within the interior 38 and the pipeline 30.

In one example, a provider of the supply 42 utilizes the quality information when determining how much to charge the destination for the gas G. The meter 10 is mounted to the pipeline 30 between the supply 42 and the destination 46. In other examples, the meter 10 may be utilized at location of the supply 42, at the location of the destination 46, or at some other location.

The meter 10 includes a controller 50 that is operationally linked to the infrared light source 14, the filter 18, and the detector 22. To monitor the components of the natural gas within the interior 38, the controller 50 initiates the movement of infrared light waves 54 within the meter 10. The waves 54 propagate from the infrared light source 14. The waves 54 are mid-infrared spectrum waves ranging. The waves 54 pass through the gas G within the interior 38.

In this example, the infrared light source 14 generates waves within the mid-infrared spectrum. The filter 18 allows some of the waves 54 to reach the detector 22, and blocks some of the waves 54 from reaching the detector 22. The example filter 18 may be a cross-interference/broadband filter device that ensures only waves having certain lengths are detected by the detector 22.

In another example, the infrared light source 14 generates some, rather than all, the waves in the mid-infrared spectrum. In such an example, the filter 18 is not used. Another filter, such as a cross-interference filter, may still be used however.

The distance D between the infrared light source 14 and the detector 22 is the optical path length of the waves 54. As the waves 54 move through the gas G toward the detector 22, alkanes in the gas G absorb some of the light. For the wavelengths that pass through the filter 18, the detector 22 detects the light that has not been absorbed by alkanes in the gas G. The detector 22 includes optical sensors for detecting the light. As known, the optical sensors may experience drift and loss of calibration.

The controller 50 utilizes this information about the detected light to determine the percentage of the waves 54 that have been transmitted through the gas G to the detector. The percentages detected by the detector 22 represent the percentages of the waves 54 that have not been absorbed by alkanes in the gas G.

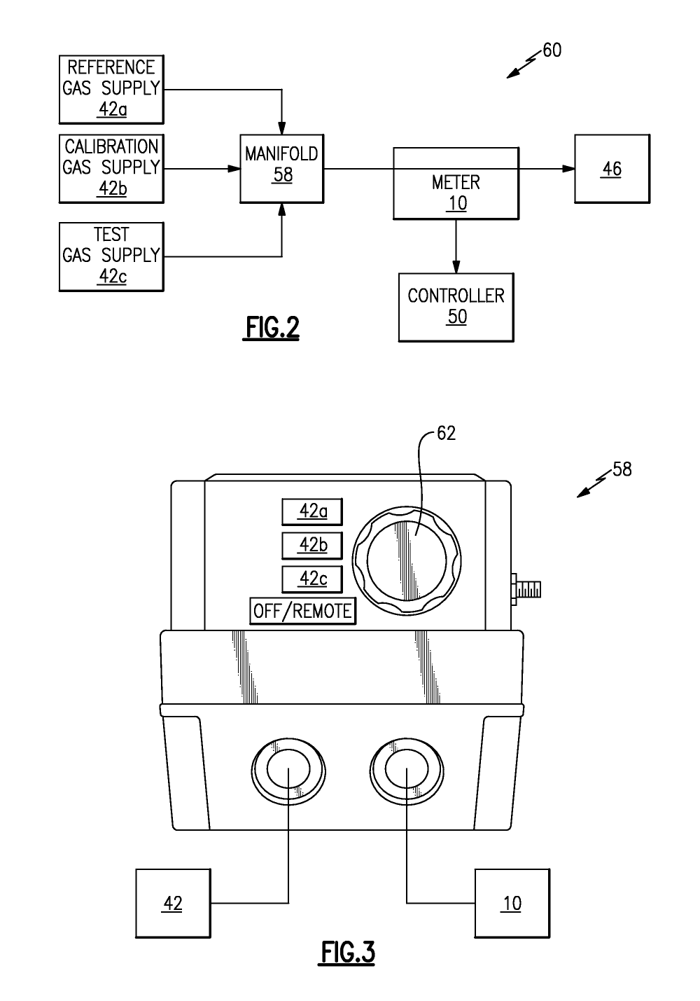

Referring to FIG. 2, an example calibration system 60 incorporating the meter 10 and the controller 50 includes a manifold 58. The manifold 58 selectively provides gas to the meter 10 from a reference gas supply 42a, a calibration gas supply 42b, or a test gas supply 42c.

In this example, the reference gas from the reference gas supply 42a is an inert gas, which has substantially no interference with waves 54 within the meter 10. Dry air and nitrogen are example types of reference gases.

The example calibration gas from the calibration gas supply 42b is a gas having a known chemical signature or composition, such as pure methane. Another example calibration gas may be a natural gas having a known chemical composition and signature.

In this example, the test gas from the test gas supply 42c is a natural gas having an unknown chemical signature.

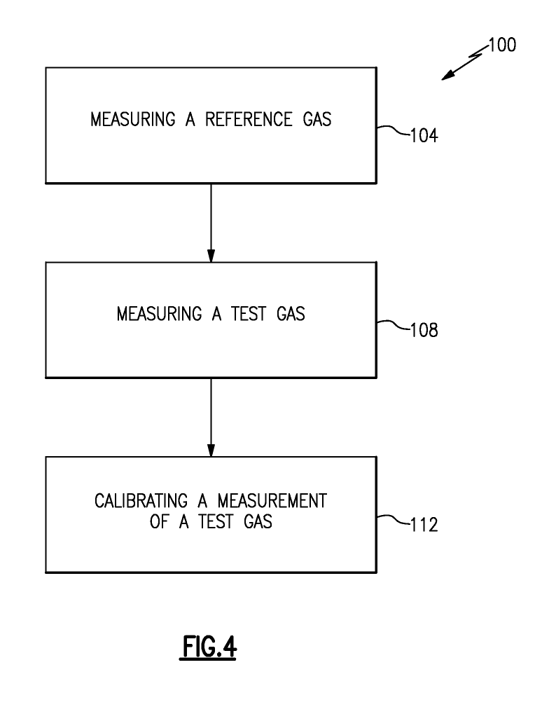

Referring to FIG. 3, the example manifold 58 includes a dial switch 62. An operator rotates the dial switch 62 to selectively move the manifold 58 to a position appropriate for supplying the reference gas, the calibration gas, or the test gas to the meter 10. In one example, valves (not shown) within the manifold 58 are opened and closed to selectively provide the gases to the meter 10 in response to a position of the dial switch 62.

Referring now to FIGS. 4-7 with reference to FIG. 2, an example method 100 of calibrating the detector using the gas components includes a step 104 of measuring an intensity of a reference gas. The method 100 then measures an intensity of a calibration gas at a step 108. At a step 112, the method 100 measures a test gas. The measurements from the steps 104 and 112 are then used to correct the test gas measurement inputs for the algorithm in FIG. 7.

In one example, an operator may be interested in ultimately determining the quality of the test gas, which may be a natural gas. In such an example, the reference gas is first provided to the meter 10 for a period of time. The reference gas is turned off and the calibration gas is turned on and provided to the meter 10 for a period of time. Then the calibration gas is then switched off and the test gas is turned on for a period of time. The period of time is dependent on the instrument and desired accuracy.

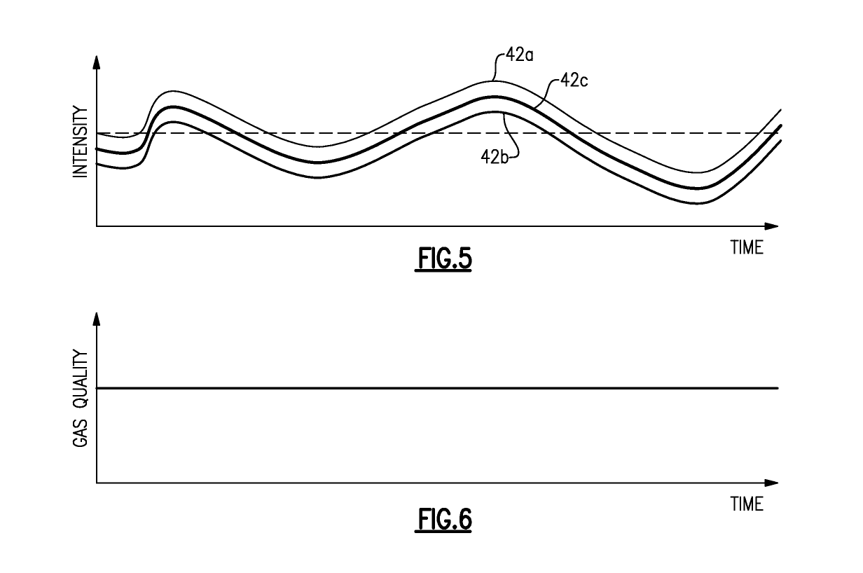

The respective intensities of the reference gas, the calibration gas, and the test gas, are then plotted as shown in FIG. 5. Since the intensity of the reference gas and calibration gas are known, variations from the known intensities may be identified as variations from a true intensity measurement due to variations within the meter 10, such as drift of optical sensors, sources, or variations in some other portion of the system 60.

In this example, both the reference gas and the calibration gas are used to calibrate the intensities of the test gas. In another example, a reference gas and calibration source that is not a gas (i.e. a liquid or solid) is used to calibrate the intensities of the test gas.

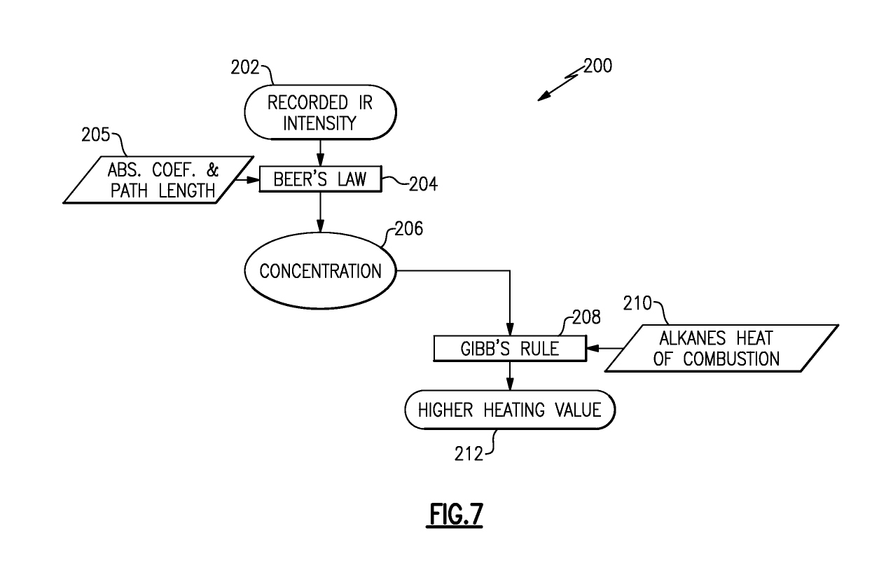

The measurements of the intensity of the test gas may be adjusted (or calibrated) based on the identified variations within the system. The adjusted intensities of the test gas are then used to determine the quality of the test gas, which can then be plotted as shown in FIG. 6. In this example, the calibrating includes the measurement of the intensity of the test gas with at least a measurement of the intensity of the reference gas and at least a measurement of the intensity of the calibration gas. As shown the measurement of the intensity of the reference gas is lower than the measurement of the test gas. The measurement of the intensity of the calibration gas can be a greater or smaller than the measurement of the intensity of the test gas. The position of the measurement intensity of the test gas relative to the calibration gas can be switched in some cases.

Referring to FIG. 7, a method 200 utilizes IR transmission to determine the quality of natural gas. The method 200 inputs the IR transmission intensities from a step 202 to a step 204.

The step 204 utilizes Beer's law to determine the concentrations of components using Equation 1 and absorption coefficients and path length from step 205.

$$O . D . = - Log ( \frac{I ( λ )}{{I}_{0} ( λ )} ) = α ( λ ) {c}_{i} l \qquad Equation 1$$

In Equation 1, O.D. stands for optical density, α(λ) is the absorption coefficient expressed in cm²/mol of a single component of the natural gas mixture at a given wavelength, cᵢ is the concentration of component i expressed in mol/cm³, and l is the optical path length of the measurement cell expressed in cm. The absorption coefficients are calculated or obtained from accepted spectral infrared databases.

In practice the measurement contains error from instrumentation and environment. The error can be traced to physical phenomena of the gas and equipment. Identification and development models for the operation of the equipment and behavior of the gas are impractical. Instead these phenomena are grouped together and considered as a whole based on materials with well characterized properties.

Baseline drift can be corrected by measuring a baseline signal utilizing a reference gas that does not absorb IR radiation at the wavelength of interest.

O.D′=O.D._{Test Gas}−O.D._{Reference} Equation 2

The corrected optical density, O.D.′, is the test gas measurement signal with the instrumentation baseline error removed. This is accomplished by subtracting the IR signal of the reference source, O.D._{Reference}, from the test gas measured signal, O.D._{Test Gas}.

The correction for instrument error can be accomplished by measuring and then comparing the absorption of IR light by the calibration gas with a known composition. These instrument errors arise from physical phenomena within the test set-up that lead to an apparent deviation in the absorption of IR light.

O.D.′=(α_{1,λ}_{₁}c₁l+α_{2,λ}_{₁}c₂l+ . . . )+(ε_{1,λ}_{₁}c₁l+ε_{2,λ}_{₁}c₂l+ . . . ) Equation 3

In equation 3, α_{i,λ}_{ⱼ} term denotes absorption coefficient of component i at wavelength j. In equation 3, all the variables are known, except for the error terms, εᵢ. The error terms for different gas species are assumed to be the same. This remains true as long as the measurements are performed with the same instrument and for non-interacting gases. For example, natural gas above its dew point behaves as a non-interacting gas.

ε_{1,λ}_{ⱼ}=ε_{2,λ}_{ⱼ}= . . . =ε_{i,λ}_{ⱼ}=ε_{λ}_{ⱼ} Equation 4

Equation 4 can be solved explicitly for the error term at each measured wavelength, ε_{λ}_{ⱼ}.

Beer's law supplies component concentrations at step 206. This information is then used as the input to step 208, the Gibb's rule summarized in Equation 5.

ΔH_{Natural Gas}=ΣᵢcᵢΔH_{combustion,i} Equation 5

In Equation 5, ΔH_{combustion,i} is the alkane heat of combustion for alkane i expressed in kJ/mol from step 210 and cᵢ is the alkane concentration in mol/cm³. In principle, the simple molar addition of the individual heats of combustion gives rise to the Higher Heating Value, 212.

In some examples, the energy flow rate of the mixture of gases is given by:

$${Q}^{\dot{ideal}} = \frac{\dot{V}}{Z ( T , P )} ( {ρ}^{ideal} Δ {H}^{ideal} ) \qquad Equation 6$$

In Equation 6, Q^{ideal} is the energy flow rate given as a function of the volumetric flow rate; \dot{V}; compressibility factor, Z(T,P); the density, ρ^{ideal}; and the mixture heat of combustion equivalent to Higher Heating Value, ΔH^{ideal}. The energy content of natural gas is an intensive thermodynamic property. A volume of natural gas has N+1 degrees of freedom, where N is the number of constituents that make up the gas mixture. In order to calculate, the exact energy content value, N+1 measurements are required. In a typical natural gas sample this would mean greater than nine independent measurements. This measurement of nine or more wavelengths corresponds to monitoring the composition of natural gas components from methane (CH3) to octane (C8H18) or higher. In a more specific example of the method 200, the algorithm development for determining the Higher Heating Value or gas quality at step 212 is composed of two equations, Beer's law at step 204 and Gibb's rule at step 208. The data flow between the two equations is shown in FIG. 7.

Specifically, the system of linear equations corresponding to the components of the gas need to be solved. The algorithmic development for calculating the Higher Heating Value of a multispecies natural gas mixture is as follows.

The expansion of Beer's law at a given wavelength to take into account multiple gas species is given below.

O.D._{λ}_{₁}=α_{1,λ}_{₁}c₁l+α_{2,λ}_{₁}C₂l+ . . . +α_{i,λ}_{₁}cᵢl Equation 7

This expression states that the absorption of infrared light at a particular wavelength is the summation of individual component absorptions.

The same expression is valid at a different wavelength:

O.D._{λ}_{₂}=α_{1,λ}_{₂}c₂l+α_{2,λ}_{₂}C₂l+ . . . +α_{i,λ}_{₂}cᵢl Equation 8

Both these equations are linear. The optical density and absorption coefficients are unique and different for each wavelength and gas mixture. However, the concentration of the gas species remains constant in each equation. Thus, a system of linear equations can be compiled to convert absorption to concentration. The system of linear equations can be converted to matrix form as shown below:

$$[ \begin{matrix}O . D {.}_{{λ}_{1}} \\ ⋮ \\ O . D {.}_{{λ}_{j}}\end{matrix} ] = [ \begin{matrix}{α}_{1 , {λ}_{1}} {l}_{1} & … & {α}_{1 , {λ}_{1}} {l}_{1} \\ ⋮ & ⋱ & ⋮ \\ {α}_{1 , {λ}_{j}} {l}_{j} & … & {α}_{i , {λ}_{j}} {l}_{j}\end{matrix} ] [ \begin{matrix}{c}_{1} \\ ⋮ \\ {c}_{i}\end{matrix} ] \qquad Equation 9$$

In Equation 9, provision was made for possibility of using different path length, lⱼ, for the measurements performed at different wavelengths, λⱼ. A simpler representation of this matrix is:

O̅.̅D̅.̅= α̅l̅c̅ Equation 10

Two methods are available to solve this expression for the concentration vector, c̅. If the matrix is square than the solution to the equation above relies on inverting the operator:

c̅= O̅.̅D̅.̅( α̅l⁻¹) Equation 11

The solution above exists for a well defined system. In practice, a system of equations is either over or under determined. In this case an approximation of the solution needs to be made to fit the observed data. This method is normally referred to as the least squares method and is shown below (The superscript T refers to the transpose of the matrix α̅l):

c̅=( α̅l̅^̅{̅T̅}̅ α̅l)⁻¹ α̅l^{T} O̅.̅D̅.̅ Equation 12

Accounting for instrument error and taking into account baseline compensation and test gas calibration, this becomes:

c̅=[ (̅α̅+̅ε̅)̅l̅^̅{̅T̅}̅ (̅α̅+̅ε̅)̅l̅]⁻¹ (̅α̅+̅ε̅)̅l̅^̅{̅T̅}̅ O̅.̅D̅.̅′̅ Equation 13

The error matrix is represented by:

$$\overline{ɛ} = [ \begin{matrix}{ɛ}_{1 , {λ}_{1}} & … & {ɛ}_{1 , {λ}_{1}} \\ ⋮ & ⋱ & ⋮ \\ {ɛ}_{1 , {λ}_{j}} & … & {ɛ}_{i , {λ}_{j}}\end{matrix} ] ≅ [ \begin{matrix}{ɛ}_{{λ}_{1}} & … & {ɛ}_{{λ}_{1}} \\ ⋮ & ⋱ & ⋮ \\ {ɛ}_{{λ}_{j}} & … & {ɛ}_{{λ}_{j}}\end{matrix} ] \qquad Equation 14$$

The simplification of the general error matrix may be applied in the more specific example of non-interacting gas.

Approaches in the past have relied on determining regions of the infrared spectra that could be speciated. In other words, concentrations of all species within a natural gas were determined individually. Only then was the higher heating value calculated. By contrast, some example methods disclosed herein remove this limitation. Specifically, these methods are applicable to convoluted spectral ranges. Convolution is due to multiple alkane absorption coefficients at a particular wavelength contributing to the overall absorption coefficient at a particular wavelength. In this region or with an apparatus that measures a convoluted spectrum, speciation is difficult. However, gas quality still can be determined. This is accomplished by taking the dot product and minimizing the Euclidean Normal, ∥ (̅α̅+̅ε̅)̅l̅ c̅− O̅.̅D̅.̅′̅∥, instead of determining gas species. The higher heating value for the mixture is then the dot product between c̅, and the heats of combustions of hydrocarbon components.

The higher heating value for natural gas mixture can be determined to an arbitrary accuracy by calculating the Euclidean Normal.

The use of the method described above and minimizing the Euclidean Normal to calculate natural gas quality are features of the disclosed examples. These features were used when evaluating a set of wavelengths in the range of eight to ten microns.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. A method of calibrating a detected intensity of gas components, comprising:
measuring an intensity of a reference gas;
measuring an intensity of a calibration gas; and
calibrating a measurement of an intensity of a test gas using at least a measurement of the intensity of the reference gas and at least a measurement of the intensity of the calibration gas.

2. The method of claim 1, wherein the calibrating comprises determining a variations in the intensity of the reference gas from known intensities of the reference gas and the test gas, and adjusting the measurement of the intensity of the test gas based on the variation.

3. The method of claim 1, wherein the reference gas is atmosphere.

4. The method of claim 1, wherein the reference gas is nitrogen.

5. The method of claim 1, wherein the test gas is natural gas.

6. The method of claim 1, wherein the calibration gas is methane.

7. The method of claim 1, included determining a quality of the test gas using a calibrated measurement of the intensity of the test gas.

8. The method of claim 1, wherein the calibrating comprises bounding the measurement of the intensity of the test gas with at least a measurement of the intensity of the reference gas and at least a measurement of the intensity of the calibration gas.

9. The method of claim 8, wherein the measurement of the intensity of the test gas is bounded between a lower measurement of the intensity of the reference gas and a higher measurement of the intensity of the reference gas.

10. A gas quality assessment system, comprising:
a detector configured to determining an intensity of a provided gas;
a manifold configured to selectively communicate a test gas, a reference gas, or a calibration gas to the detector as the provided gas; and
a controller configured to determine a calibrated intensity measurement of the test gas, wherein the calibrated intensity measurement is calibrated based on an intensity measurement of the reference gas and the calibration gas.

11. The gas quality assessment system of claim 10, wherein the controller is configured to further determine a quality of the test gas using the calibrated intensity measurement.

12. The gas quality assessment system of claim 10, wherein the calibration gas is methane.

13. The gas quality assessment system of claim 10, wherein the reference gas is atmosphere.

14. The gas quality assessment system of claim 10, wherein the reference gas is nitrogen.

15. The gas quality assessment system of claim 10, wherein the gas is natural gas.
